(19) United States
(12) Patent Application Publication
(10) Pub. No.: US 2013/0186280 A1
(43) Pub. Date: Jul. 25, 2013

(54) Compressed Coffee Drip Brewer

(71) Applicant: Kiyoshi Sekiguchi, Richardson, TX (US)

(72) Inventor: Kiyoshi Sekiguchi, Richardson, TX (US)

(21) Appl. No.: 13/356,426

(22) Filed: Jan. 23, 2012

(51) Int. Cl. A47J 31/00

(52) U.S. Cl. 99/287

(57) ABSTRACT

A coffee brewer for making coffee may include a receiving container for receiving the brewed coffee, an exterior container being detachably mounted on the receiving container, and an interior container to cooperate with the exterior container. The interior container may rotates with respect to the exterior container. The interior container may include an exterior surface having a male thread. The exterior container may include an interior surface having a female thread to cooperate with the male thread of the interior container. The exterior container may include substantially a cylinder. The interior container may include substantially a cylinder.

### FIELD OF THE INVENTION

The present invention relates to a coffee brewers and more particularly to a compressed coffee drip brewer for brewing coffee with improved flavor.

### BACKGROUND

Portable coffee makers are known. For example, U.S. Pat. No. 7,506,577 discloses a machine for dispensing beverages, e.g. tea or coffee, the operation of which is subject to the use of prepackaged one-cup pods. The machine according to the invention comprises a revolving member, complete with a seat for containing a pod, which cooperates with a hook, and a water heating and delivery unit including a one-way flow valve which is opened when a given pressure is exceeded. The water heating and delivery unit is driven by an operating unit to compress said pod when the revolving member occupies the working position for the preparation and delivery of a beverage. The revolving member subsequently completes a turn during which the pod contained in the seat is removed by means of the hook.

U.S. Pat. No. 6,062,127 discloses a portable espresso maker comprising a housing and a water chamber within the housing and having an o-ring mounted on the top edge. There is a heating element adjacent the bottom of the water chamber. There is a bottom tray for holding the housing and a cup positioned on the bottom tray adjacent the housing. A filter assembly is positioned within the water chamber and comprises a filter tube connected to a reservoir. A mesh screen extends over the bottom of the reservoir. A cover is positioned over the housing and the water chamber. The cover has an o-ring that engages the o-ring mounted to the water chamber to create an air-tight seal between the water chamber and the cover. The cover has a concave recess and a screen extending over the concave recess. There are a plurality of ridges positioned within the recess and extending to the screen. An exit spout extends from the recess out of the cover and toward the cup. A prepackaged coffee packet is placed on the screen of the filter element and the cover is mounted to the housing so that the ridges press against the screen of the cover element to compress the coffee. Water in the water chamber is heated by the heating element and travels up through the filter tube and the coffee packet between the screens and exits out the exit spout into the cup to make a single cup of brewed espresso.

U.S. Pat. No. 5,970,850 discloses device for brewing hot beverages comprises a lower container for receiving water, an upper container for receiving brewed beverage, and a piston-cylinder assembly into which coffee grounds, tea leaves, and herbs are placed. The grounds, etc. are compressed and subjected to high temperature water and steam, to extract essences and produce a beverage, such as espresso coffee. The piston has a decompression chamber at its upper end, formed between the piston top and a perforated diffuser plate. Pressurized hot water from the lower container flows through a nozzle in the piston top, into the decompression chamber, through the holes of the diffuser plate, and then into the grounds. The piston moves upwardly to compress the grounds against an upper perforated plate, first with rising force, and then with constant force. Since the total flow path cross sectional area of the holes in the diffuser plate is several times greater than the flow area of the piston top nozzle, the pressure in the decompression chamber is substantially lower than the pressure in the lower container. This enables a lowered velocity of water and steam which pass through the diffuser plate and into the grounds.

U.S. Pat. No. 5,937,737 discloses a disposable filter device having a member to confine and a member to compress coffee grounds or tea leaves within the filter device. This enables controlled brewing while the device remains within the cup. The device may be permanently configured as a frame within a cup, or the device may be configured so as to have a rigid frame to be portable from cup to cup, using available disposable filters or single serving coffee or tea bags.

U.S. Pat. No. 5,237,911 discloses a coffee brewing machine, comprising a container for fresh cold water, a boiler for heating the fresh cold water, a brewing chamber adapted to receive coffee powder, a pump for feeding the fresh cold water from the container to the boiler and therefrom into the brewing chamber, a piston fitting into the brewing chamber and being movably mounted such that it can be moved into the brewing chamber to compress the coffee powder contained in the brewing chamber and removed from the brewing chamber, and an electric DC motor for driving the piston into the brewing chamber and for retracting it out of the brewing chamber. In order to provide for a simple connection of the electric motor to the mains voltage, a drop resistor and a rectifier diode are connected in series with the electric motor. The drop resistor simultaneously serves as a heating element for a hotplate on which the coffee cups can be preheated.

### SUMMARY

A coffee brewer for making coffee may include a receiving container for receiving the brewed coffee, an exterior container being detachably mounted on the receiving container, and an interior container to cooperate with the exterior container.

The interior container may rotate with respect to the exterior container.

The interior container may include an exterior surface having a male thread.

The exterior container may include an interior surface having a female thread to cooperate with the male thread of the interior container.

The exterior container may include substantially a cylinder.

The interior container may include substantially a cylinder.

The exterior container may include a bottom wall having an aperture.

The interior container may include a bottom wall having an aperture.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the coffee maker of the present invention;

FIG. 2 illustrates a bottom view of the coffee maker of the present invention;

FIG. 3 illustrates a top view of the coffee maker of the present invention;

FIG. 4 illustrates a flowchart for making coffee using the coffee maker of the present invention.

### DETAILED DESCRIPTION

The present invention provides richer coffee, adding flavor, body, aroma and mellowness by compressing the ground coffee or pre-packaged ground coffee before boiling water is added to the ground coffee or pre-packaged ground coffee. By rotating the interior container 151 clockwise with respect to the exterior container 111, the ground coffee or pre-packaged ground coffee which may be sandwiched between the bottom wall 131 and the bottom wall 155 are compressed allowing the boiling water to go through the compressed coffee grounds slowly and saturating the ground coffee or pre-packaged ground coffee, giving sufficient time to extract flavors and oils from the compressed coffee. When the interior container 151 is rotated counter clockwise in the opposite direction with respect to the exterior container 111, the saturated coffee grounds expands and brings out flavors and oils to further enhance the coffee. The threaded exterior container 111 and the threaded interior container 151 may compress the coffee ground into a hard puck at the bottom of the brewer. Once the interior threaded container 151 engages the ground coffee, an additional rotation of the threaded interior container ½ to 1½ turns may be sufficient to compress the coffee grounds.

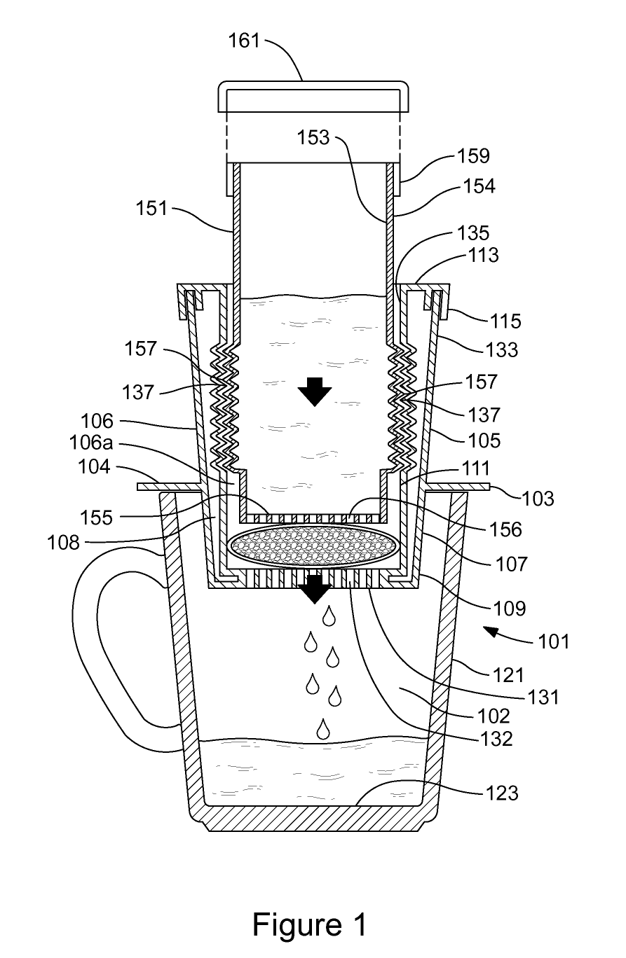

FIG. 1 illustrates a cross-sectional view of a coffee maker 100 of the present invention and illustrates a receiving container 101 which may be a coffee cup or a coffee pot. The coffee maker 100 may be formed from entirely or in combination with metal such as stainless steel, aluminum, glass, plastic, porcelain or other similar types of materials. The receiving container 101 may be formed as a substantial cylinder, oval, a rectangle or other appropriate shape and may include a sidewall 121 which may extend around the periphery of the cylinder, a bottom wall 123 which may extend around the periphery of the sidewall 121 and a container rim 103 which may be positioned substantially perpendicular to the sidewall 121 and may extend radially inwards and radially outwards from the sidewall 121. The container 101 may be hollow having a cavity 102 for receiving the coffee. The container rim 103 may include a radial inward section 104 which may extend radially inwards in order to alternatively connect to a upward extending substantially cylinder 105 (defining a cavity 106a) which may include a cylinder sidewall 106 without a top or bottom or/and alternatively or together the radial inward section 104 may connect to a downward extending substantially cylinder 107 (defining a cavity 108) which may terminate in a L-shaped section 109 (rotated 90°) in order to support the bottom wall 131 of an external container 111. The L-shaped section 109 may cooperate with the bottom wall 131 of the exterior container 111.

The external container 111 may be substantially a cylinder and may include an external sidewall 133 which may include an interior surface 135 which may include a first fastener such as first threads 137 (including a single thread) to cooperate and threadably operate with a second fastener such as second threads 157 (including a single thread) of the internal container 151. The external sidewall 133 may be connected to the periphery of the external bottom wall 131 which may include apertures 132 which may extend through the bottom wall 131 in order to allow the coffee to escape into the receiving container 101.

The exterior side wall 135 may be connected to an upper lid 113 which may extend radially from the sidewall 135 and the upper lid may include an inverted U-shaped section 115 to connect and cooperate with the cylinder 105.

The external container 111 may be detachably connected to the receiving container 101 and the external container 111 may be rotatably connected to the internal container 151 by cooperation of the first threads 137 (female) with the second threads 157 (male) to advance and retract the internal container 151 within the external container 111.

The interior container 151 may be a cylinder and may be sized to nest within the external container 111. The interior container 151 may include a sidewall 153 which may include an exterior surface 154 which may have second threads 157 to cooperate with the first threads 137. The interior container 151 may include an interior bottom wall 155 which may include apertures 156 which may extend through the interior bottom wall 155 to allow hot water to reach the ground coffee or pre-packaged ground coffee being sandwiched between the exterior bottom wall 131 and the interior bottom wall 155. The exterior surface of the upper portions of the interior side wall 153 may include a thermal break band 159 which may cooperate to provide a friction fit with the lid 161 so that the lid 161 is detachably connected to the interior side wall 153.

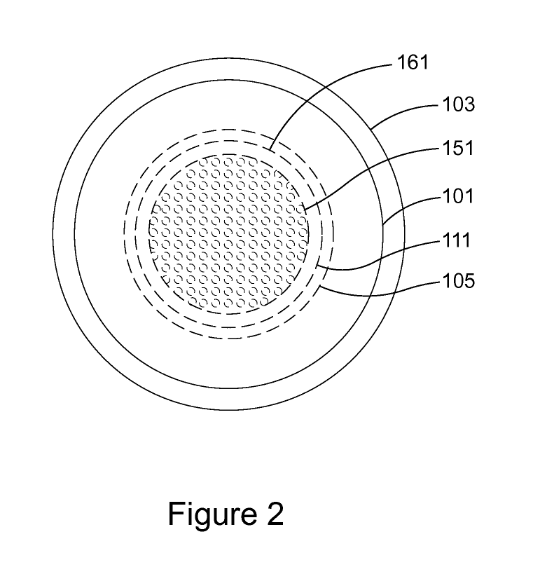

FIG. 2 illustrates a bottom view of the coffee maker 100 of the present invention and illustrates the receiving container 101, the container lid 103, substantially upward extending cylinder 105, the lid 161, the exterior container 111 and the interior container 151.

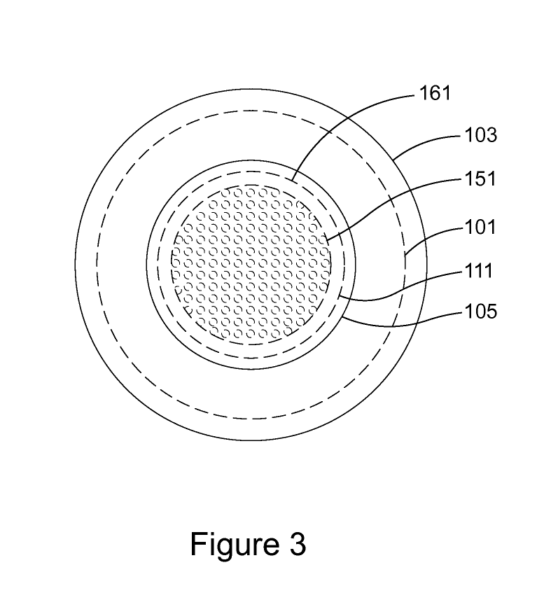

FIG. 3 illustrates a top view of the coffee maker 100 of the present invention and illustrates the receiving container 101, the container lid 103, substantially upward extending cylinder 105, the lid 161, the exterior container 111 and the interior container 151.

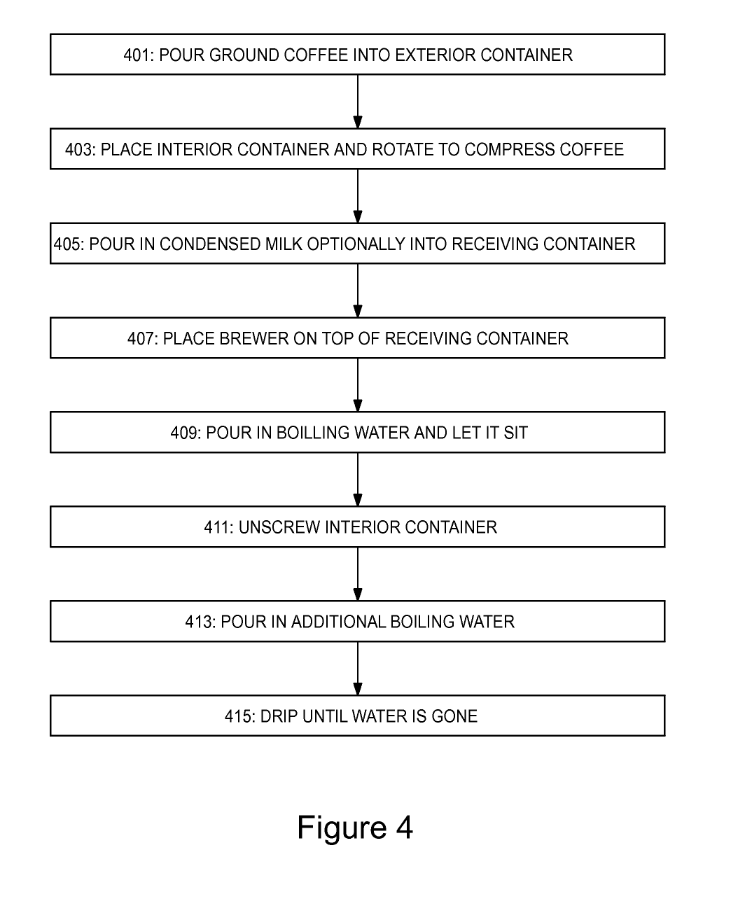

FIG. 4 illustrates the steps for making coffee and employing the coffee maker 100 of the present invention. In step 401, ground coffee or pre-packaged ground coffee is placed into the external container 111 for example 2 teaspoons of the ground coffee, and in step 403, the interior container 151 is placed into the exterior container 111 and rotated for example clockwise for example until resistance from the coffee is noted, for example ½ to 1½ turns. In step 405, sweetened condensed milk may be optionally added for example 3 tablespoon, and in step 407, the brewer is placed on top of the receiving container 101. In step 409, boiling water, for example 20 cc is added and the water sits until it disappears, and in step 411, the interior container 151 is rotated for example counter clockwise for example one half turn or until there is no resistance. In step 413, additional boiling water is added for example 150 cc, and in step 415, the coffee is left to drip until the water is gone.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A coffee brewer for making coffee, comprising:
a receiving container for receiving the brewed coffee;
an exterior container being detachably mounted on the receiving container;
an interior container to cooperate with the exterior container;
wherein the interior container rotates with respect to the exterior container.

2. A coffee brewer for making coffee as in claim 1, wherein the interior container includes an exterior surface having a male thread.

3. A coffee brewer for making coffee as in claim 2, wherein the exterior container includes an interior surface having a female thread to cooperate with the male thread of the interior container.

4. A coffee brewer for making coffee as in claim 1, wherein the exterior container is substantially a cylinder.

5. A coffee brewer for making coffee as in claim 1, wherein the interior container is substantially a cylinder.

6. A coffee brewer for making coffee as in claim 1, wherein the exterior container includes a bottom wall having an aperture.

7. A coffee brewer for making coffee as in claim 1, wherein the interior container includes a bottom wall having an aperture.
